(19) United States
(12) Patent Application Publication
(10) Pub. No.: US 2013/0263689 A1
(43) Pub. Date: Oct. 10, 2013

(54) BIKE STEM APPARATUS

(71) Applicant: Jeffrey B. Robinson, Gladwyne, PA (US)

(72) Inventor: Jeffrey B. Robinson, Gladwyne, PA (US)

(21) Appl. No.: 13/475,557

(22) Filed: May 18, 2012

Related U.S. Application Data
(60) Provisional application No. 61/621,014, filed on Apr. 6, 2012.

(51) Int. Cl. G05G 1/12

(52) U.S. Cl. 74/548

(57) ABSTRACT

The invention relates to a bike stem and more generally to a stem for connecting a steering bar to a steering tube. The stem body is substantially hollow allowing the use of a locking member to engages the handlebar on one end and the steerer tube on the other end and can be secured by tightening bolts on only one end of the bike stem, thereby exerting pressure on the handlebars and to the locking member, which thereby applies a force to the steerer tube, securing the steerer tube to the bike stem without the need for bolts on the steerer tube side of the bike stem.

### CROSS-REFERENCE TO RELATED APPLICATION

This application claims priority to U.S. provisional application Ser. No. 61/621,014 filed Apr. 6, 2012, which is incorporated herein by reference in its entirety.

### BACKGROUND OF THE INVENTION

The present application is related generally to a bike stem, and more particularly to a bike stem comprising a locking member situated in a cavity within the bike stem that secures handlebars and a steerer tube to the bike stem through the use of a clamping mechanism on the handlebar side of the bike stem.

In bicycle construction, a bike stem is an apparatus that secures the handlebars to the steerer tube. This apparatus generally includes a clamp on each end of the bike stem, one aligned in a general horizontal manner to secure a handlebar and another clamp aligned in a general vertical manner to secure the bike stem to the steerer tube. These clamps include a receiving aperture having a generally horizontal axis for receiving handlebars in the generally horizontal manner on one end, and a receiving aperture having a generally vertical axis on the steerer tube end to receive a steerer tube in a generally vertical manner. The bike stem can then be secured to the steerer tube and handlebars with the clamps surrounding the handlebars and steerer tube, attaching all the parts together to allow a rider to steer the bicycle.

Current bike stems possess a problem in that the clamping mechanism on the steerer tube side adds weight to the bike stem, and is also susceptible to contact with the rider. The steerer tube clamping mechanism and bolts, therefore, add weight and protrude towards the rider, to secure the stem to the steerer tube.

### SUMMARY OF THE INVENTION

It is an object of the invention to provide a new and improved light weight, non-obtrusive bicycle stem which can secure handlebars and steerer tube with a clamping mechanism situated at only one end of the longitudinal axis of the bike stem.

The clamping mechanism situated on the steerer tube end of the bike stem is removed in the invention described herein. In the prior art, the clamping mechanism on the steerer tube side is necessary to secure the bike stem to the steerer tube, however, the clamping mechanism and bolts necessary to secure the clamping mechanism protrude from the steerer tube towards the rider. The invention described herein eliminates the clamping mechanism from this end of the bike stem, thereby eliminating the clamping mechanism and bolts, which are replaced by a smooth, thin walled aperture, reducing unintended rider contact with the bike stem. Furthermore, by eliminating the clamping mechanism on the steerer tube side, weight is eliminated from the bike stem.

In accordance with the invention, this and other objects are attained by providing a bicycle stem where the stem body comprising a longitudinal axis with a first a second longitudinal end, where the first longitudinal end comprises a continuous surface defining a circular vertically configured opening and the second end comprising a horizontally configured bearing surface. The body comprising a longitudinal cavity connecting the vertical and horizontal openings. Inside the cavity is situated a locking member. The locking member comprises two ends, a height, length, and width, where the ends each comprise a curved bearing face to accept a tube. The first end bearing face accepts a tube in a substantially vertical manner, and the second end comprising a curved bearing face configured to accept a tube in a substantially horizontal manner. The locking member is of such length that the locking member protrudes into the first and second longitudinal ends of the bike stem. A clamping mechanism is situated to attach to the front end so as to secure a handlebar tube between the clamping mechanism and the opening at the front end of the stem body.

According to another aspect of the invention, a steering stem for attaching a steering bar to a steering tube where the stem body comprises longitudinal axis including first and second longitudinal end regions, where the first end comprises a continuous surface defining a circular vertically configured opening and the second end comprising a bearing surface. A cavity within the longitudinal axis of the steering stem connects the vertical and horizontal openings. Inside the cavity is situated a locking member, the locking member comprising a first and second end, with each end comprising a curved bearing face to accept a tube, the first end in a substantially vertical manner, and the back end configured to accept a tube in a substantially horizontal manner. The locking member is of such length that the locking member protrudes into the vertically configured opening at the back end of the bike stem and into the horizontally configured opening at the front end of the stem. A clamping mechanism with a bearing face in opposed relation to the second longitudinal end is situated to attach to the second end so as to secure a steering bar between the clamping mechanism and the opening at the second end of the stem body.

According to another aspect of the invention, a bike stem comprising a stem body with a longitudinal axis and comprising a first and second longitudinal end regions. Said first longitudinal end comprising a circular vertically configured opening and said second end comprising a horizontally configured bearing surface. The stem body further comprising a cavity connecting the first and second ends of the stem body. A locking member comprising a first end and a second end and configured to a height and width to fit within the cavity and of such a length that it is slightly longer than the length of the cavity, and a clamping mechanism on the second longitudinal end of the bike stem, comprising a curved face to accept a tube and said clamping mechanism being configured to receive threaded fasteners to secure handlebars and steerer tube by securing the clamping mechanism at the second end of the bike stem.

According to another aspect of the invention, a bike stem comprising a stem body, said stem body comprising a cavity connecting the front and rear ends of the stem body, a locking member fitting within the cavity, and of such a length that it is slightly longer than the length of the cavity, and a clamping mechanism affixed to the stem body with a moveable pivot and allowing the handlebars and steerer tube to be secured to the bike stem with a fastening device.

According to another aspect of the invention, a bicycle stem having a longitudinal axis including first and second ends, where the first end has a continuous surface defining a tubular opening extending through the stem body for receiving a first member, and the second end comprising a bearing surface. A cavity extends longitudinally through the opening at one end to the opening at the other end. A locking member, movably situated in the body cavity having a longitudinal axis with first and second ends, said ends each having a locking surface, where the length of the locking member is greater than the distance between the continuous surface defining the tubular opening at one end, and the bearing surface at the other end. A clamping device situated at said second end region have a clamping surface in opposed relationship to the bearing surface at said second end and defining a clamping space between them, structured to clamp a second member within said clamping space between said clamping surface and said bearing surface.

### BRIEF DESCRIPTION OF THE DRAWINGS

FIG. 1A and FIG. 1B are perspective views of two embodiments of the invention described herein.

FIG. 2 is a perspective view of one embodiment of the invention described herein.

FIG. 3 is a perspective view of one embodiment of the intention described herein.

FIGS. 4A, 4B, 4C, and 4D are perspective views of one aspect of one embodiment described herein taken from four different angles.

FIGS. 5A, 5B, 5C, and 5D are perspective views of one aspect of an embodiment of the invention described herein taken from four different angles.

FIGS. 6A, 6B, 6C, and 6D are perspective views of one embodiment of the invention described herein taken from four different angles.

FIGS. 7A, 7B, 7C, and 7D are perspective views of one embodiment of the invention described herein taken from four different angles.

FIGS. 8A, 8B, 8C, and 8D are perspective views of one embodiment of the invention described herein taken from four different angles.

FIGS. 9A, 9B, 9C, and 9D are perspective views of one embodiment of the invention described herein taken from four different angles.

FIGS. 10A, 10B, and 10C are perspective views of one embodiment of the invention described herein taken from four different angles.

### DETAILED DESCRIPTION OF THE PREFERRED EMBODIMENTS

The embodiments of the invention and the various features and advantages thereto are more fully explained with reference to the non-limiting embodiments and examples that are described and illustrated in the accompanying drawings and set forth in the following descriptions of those drawings. The figures in the accompanying drawings are not necessarily drawn to scale and the feature of one embodiment may be employed with the other embodiments as the skilled artisan recognizes, even if not explicitly stated herein. Descriptions of well-known components and techniques may be omitted to avoid obscuring the invention. The examples used herein are intended merely to facilitate an understanding of ways in which the invention may be practiced and to further enable those skilled in the art to practice the invention. Accordingly, the examples and embodiments set forth herein should not be construed as limiting the scope of the invention, which is defined by the appended claims.

As used herein, terms such as “a,” “an,” and “the” include singular and plural referents unless the context clearly demands otherwise.

As used herein, the term “about” means within 10% of a defined number. For example “about 100 mm” includes lengths of 90 mm-to 110 mm.

An advantage of the invention described herein is the ability to remove weight from the bike stem, eliminate a clamping mechanism from the steerer tube side of the bike stem, and allow for a single clamping mechanism to secure the bike stem to the handlebars and steerer tube. This provides a benefit in reducing the unintended rider contact with the clamping mechanism, reducing weight, and allowing for faster and easier changes of a bike stem. Furthermore, the steerer tube can be removed from a bike and exchanged without the need to remove eight threaded fasteners, as is typically required in the prior art. The invention described herein provides for a clamping mechanism that requires no threaded fasteners, or 1, 2, 3, 4, or more threaded fasteners on the handlebar side of the bike stem.

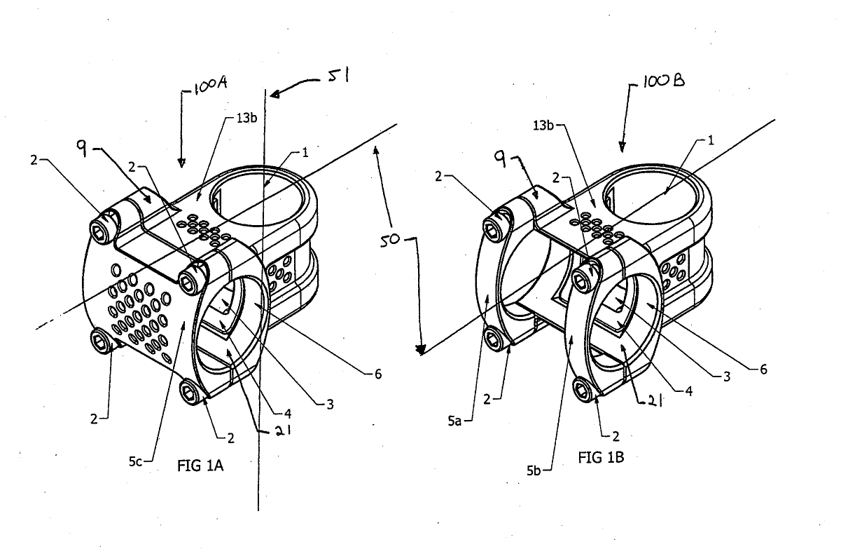

Two embodiments of the bike stem 100A and 100B are illustrated in FIG. 1A and 1B. According to the invention described herein, each bike stem 100A and 100B comprise at least one clamping member either 5c alone, or 5a and 5b, which can be fastened at the respective end of the stem body 13b using threaded fasteners 2 received in corresponding threaded apertures 9. FIGS. 1A and 1B have one variation, namely, the stem clamping member of stem 100A (FIG. 1A) being constituted by a single stem clamping member 5c, whereas stem 100B (FIG. 1B) being constituted by two clamping members 5a and 5b in FIG. 1B. The remaining aspects of the embodiments of FIGS. 1A and 1B are the same and are described together.

Stem body 13, includes sides 13a (not shown) and 13b, which constitutes the top and bottom of the stem body. Herein, the stem body is generally depicted as 13, and in the figures, the particular sides are referred to as either 13a or 13b for clarity. Stem body top and bottom 13b refers to, and is, the top and bottom of the stem body, which is oriented so that the steerer tube opening 1 has a substantially vertical axis 51. Stem body sides 13a refers to the sides of the stem body so that when the 13a side is oriented face up, the steerer tube opening 1 is in a substantially horizontal axis. The sides 13a and 13b are substantially parallel to the longitudinal axis 50.

FIGS. 1A and 1B according to an embodiment of the invention described herein show the handlebar opening 21 aligned in a horizontal plane, so that handlebars can be attached to the stem body 13 and secured in a generally horizontal manner. The stem body 13 comprises a handlebar end comprising a handlebar contact face 6 which, when configured with the stem clamping members 5a-5c creates a handlebar opening 21 that can accept a handlebar. By use of the clamping members 5a-5c, a handlebar can be securely attached between the stem body 13b and the clamping members.

The stem body 13 according to one embodiment of the invention comprises a longitudinal axis with a first and second end. The first end being the steerer tube opening, which has a continuous surface defining a tubular opening. The second end being the handle bar side, comprising a bearing surface face. The stem body 13 further comprises a cavity (or referred to as a “shaft”) 8 opening within the longitudinal axis of the stem body 13 which extends into the handlebar contact face 6 on one end and into the steerer tube opening 1 on the other end. This cavity 8 receives a locking member 3 within the cavity 8. The locking member 3 is of such height and width that it fits within the cavity 8, but is moveable, but is also of such length that it protrudes slightly into the steerer tube opening 1 and also into the handlebar opening 21. In this manner, when a handlebar is secured in the handlebar opening 21, and the threaded fasteners 2 secure the stem clamping members 5c, or 5a/5b, the handlebar will be in contact with the handlebar clamping face 4 of the locking member 3. Where a steerer tube is also situated in the steerer tube opening 1, by securing the threaded fasteners, the steerer tube will be in contact with the steerer tube contact face 15 of the locking member 3. By tightening threaded fasteners 2 and tightening a clamping member 5, the clamping faces 4 and 15 can exert pressure on both the steerer tube and the handlebar, securing the bike stem to the handlebar and steerer tube.

The embodiments of FIGS. 1A and 1B, as well as all other embodiments of the invention described herein can be made of various materials, including, but not limited to plastics, metals, fiber glass, metal alloys, and any combination thereof. Example metals or metal alloys are steel, steel alloys, aluminum and aluminum alloys, titatiun and titanium alloys, and other lightweight metals and metal alloys. For example, it may be advantageous to have the majority of the bike stem be made of carbon fiber, but have some elements made of other materials, such as a metal. However, this is but one example of the materials that can be used. Certainly, the materials used may change based on the reducing the weight of the bike stem, the strength needed, and the cost associated with the manufacturing of the invention.

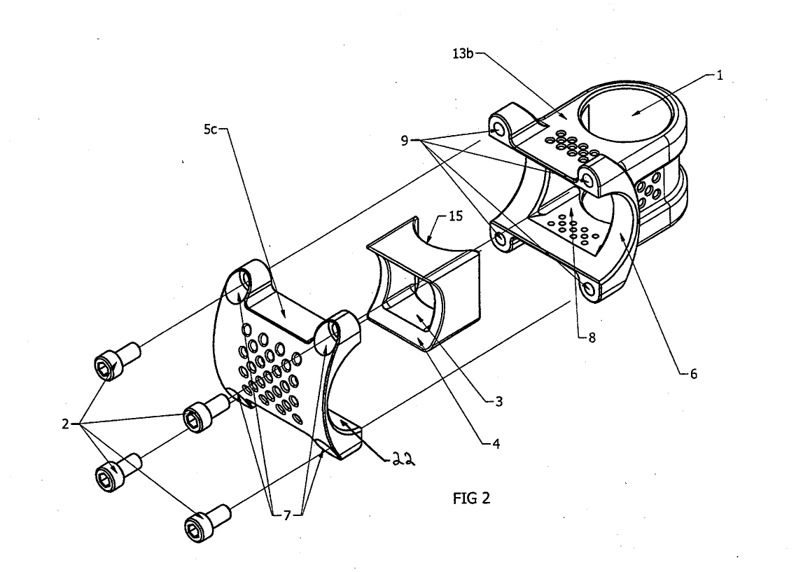

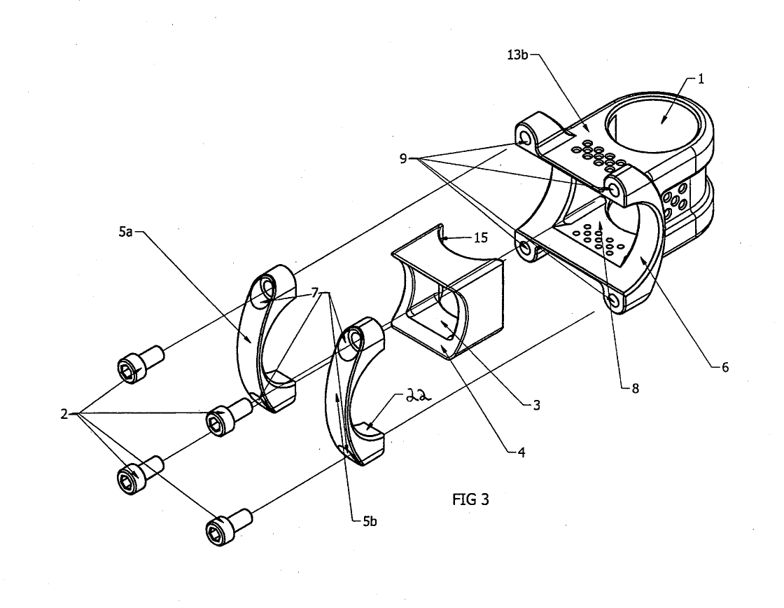

As illustrated in FIGS. 2 and 3, an embodiment of the bike stem according to the invention is shown in an expanded view, to show how the locking member 3, fits within the cavity 8. The cavity 8 is a longitudinal opening within the stem body, where the cavity extends from the opening at the steerer tube opening end and through to the bearing surface end at the handlebar end of the bike stem. The length of the cavity may be from about 1 mm to about 500 mm, from about 2 mm to about 250 mm, about 5 mm to about 100 mm, about 10 mm to about 75 mm, about 20 mm to about 50 mm, and about 40 mm. The stem body 13 includes a first handlebar contact face 6 on the handlebar side that is configured to receive a handlebar. The handlebar contact face 6 may be of a generic size or curvature so as to receive and secure any diameter handlebar, or, may be specifically tailored to a specific diameter handlebar as needed. Handlebar tubes generally come in sizes ranging from about 20 mm to about 60 mm in diameter. This invention is intended to encompass any handlebar tube, including any handlebar with a diameter of about 10 to about 100 mm, about 20 mm to about 60 mm, about 20 mm to about 50 mm, and about 20 mm to about 40 mm, and also include any handlebar with a tube diameter greater or smaller than what is currently used in the marketplace. The handlebar contact face 6 is configured such that a handlebar is placed within against the handlebar contact face 6 and a clamping member 5 may be secured to the stem body 13, such that the clamping member contact face 22 is also in contact with the handlebar. The clamping member 5 is secured by threaded fasteners 2 and the threaded fasteners 2 can tighten the clamping member 5 so as to secure the handlebar so it does not slide either rotationally or in a lateral manner. The locking member 3 also has a handlebar clamping face 4, and when the handlebar is secured in the handlebar opening 21, the handlebar will be in contact with the handlebar clamping face 4. The pressure exerted by securing the clamping member with the four threaded fasteners 2 into the corresponding threaded apertures 7 can then secure both the handlebars and the steerer tube by tightening the threaded fasteners on the handlebar side of the bike stem and by the contact with the handlebar clamping face 4 and the steerer tube clamping face 15, situated on the locking member 3.

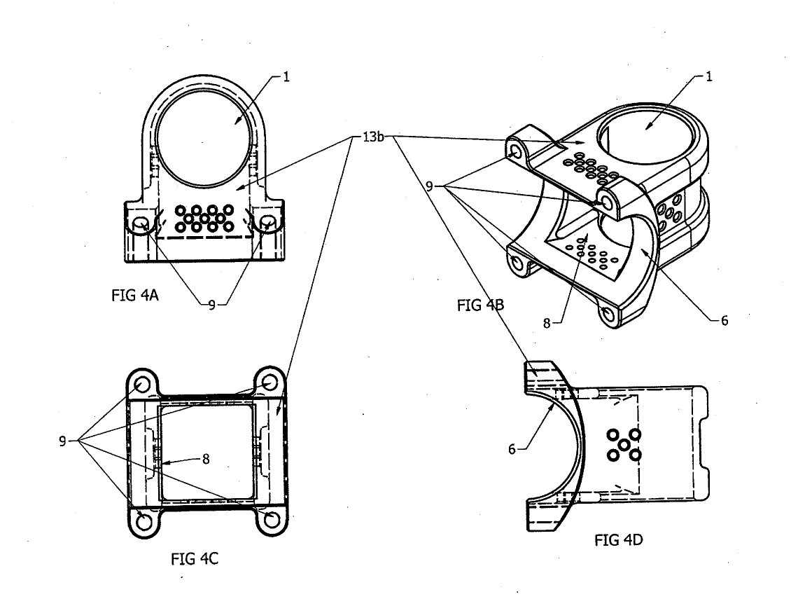

As illustrated in FIG. 4, an embodiment of the invention is shown where the stem body 13, is pictured from different orientations to show the features of the embodiment. There is no clamping mechanism on the steerer tube side, only a steerer tube opening 1, which is defined to accept a steerer tube. The steerer tube opening 1 is a circular opening of such diameter to accept a steerer tube. The diameter of the steerer tube opening 1 is from about 10 to about 100 mm, about 20 to about 60 mm, about 20 to about 50 mm, and about 20 to about 40 mm. The diameter is intended to encompass all current commercially available steerer tubes for recreational, mountain bike, road bikes, as well as specialized downhill and racing bikes.

FIG. 4B shows an embodiment of the invention described herein and identifies the curvature of the handlebar contact face 6, as well as the cavity 8. Similarly, the cavity 8 is shown in FIG. 4C from a different orientation.

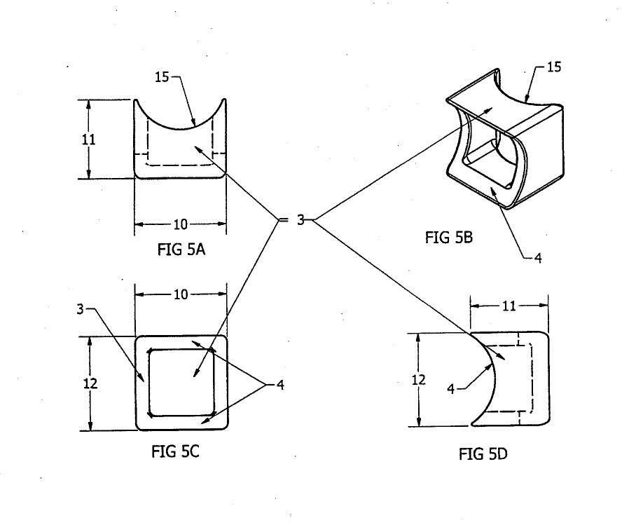

As illustrated in FIG. 5, an embodiment of the locking member 3 according to the invention described herein, is of such size to fit within the cavity 8, and further comprises a handlebar clamping face 4 and a steerer tube clamping face 15. The locking member 3 comprises a longitudinal axis, a face at each longitudinal end, and four sides, a locking member length 11, width 10, and height 12. The two faces are aligned in a perpendicular manner, such that the handlebar clamping face is in a substantially horizontal manner, and the steerer tube clamping face is in a substantially vertical manner. Each face is defined to accept a tube of a diameter from about 10 to about 100 mm, about 20 to about 60 mm, about 20 to about 50 mm, and about 20 to about 40 mm. The locking member length 11, width 10, and height 12 are defined by the particular embodiment. In particular, the locking member width 10, and height 12, depends on the internal dimensions of the cavity 8 and the dimensions are such that the locking member 3 is movable within the cavity 8. The locking member length 11 is defined by the length of the cavity 8. The locking member length 11 is about 1 mm to about 500 mm, from about 2 mm to about 250 mm, about 5 mm to about 100 mm, about 10 mm to about 75 mm, about 20 mm to about 50 mm, and about 40 mm. The locking member length will be about 0.1 mm to about 10 mm, about 0.5 mm to about 5 mm, about 1 mm to about 3 mm, and about 2 mm longer than the length of the cavity 8 in a given embodiment.

The embodiment of FIG. 5 shows the locking member 3 that further includes a hollow center. Thus, the faces of the handlebar clamping face 4, and the steerer tube clamping face comprise a width of from about 0.1 mm to about 15 mm, and about 1 mm to about 5 mm. The faces of the locking member are configured to be in contact with the handlebar or steerer tube and to transfer pressure from the handlebar onto the steerer tube, thereby securing the steerer tube.

The handlebar clamping face 4 and steerer tube clamping face 15 according to one embodiment of the invention may be smooth, machined, rough, or may include additional materials to increase the friction between the faces and either the handlebars or the steerer tube. The faces may also have grooves and be paired with a particularly manufactured handlebar tube or steerer tube with corresponding grooves. The handlebar clamping face 4 and steering tube clamping face 15 may be perpendicular to each other, but also may be aligned at other angles as necessary for proper attachment of the handlebar and steerer tube. For example, the steerer tube or the handlebar, or both may be offset at an angle to allow for proper fit and geometries of a rider.

The Locking member 3, according to an embodiment of the invention described herein may be hollow as shown in FIGS. 5A, 5B, 5C, and 5D, but may also be configured where there is no hollow center to the locking member 3. In such an embodiment, the handlebar clamping face 4 and steerer tube clamping face 15 would be the entire width and height of the locking member. The surface of the faces may entirely comprise smooth, machined, rough faces, or may include additional materials added to the face to increase friction. Similarly, the faces may comprise a groove and channel type system to secure the pieces together, or other lock and key design to secure the steerer tube and or the handlebar. The surface of the faces may comprise multiple surfaces on the face. For example, a face may include some portions that are rough and others smooth, as one non-limiting example.

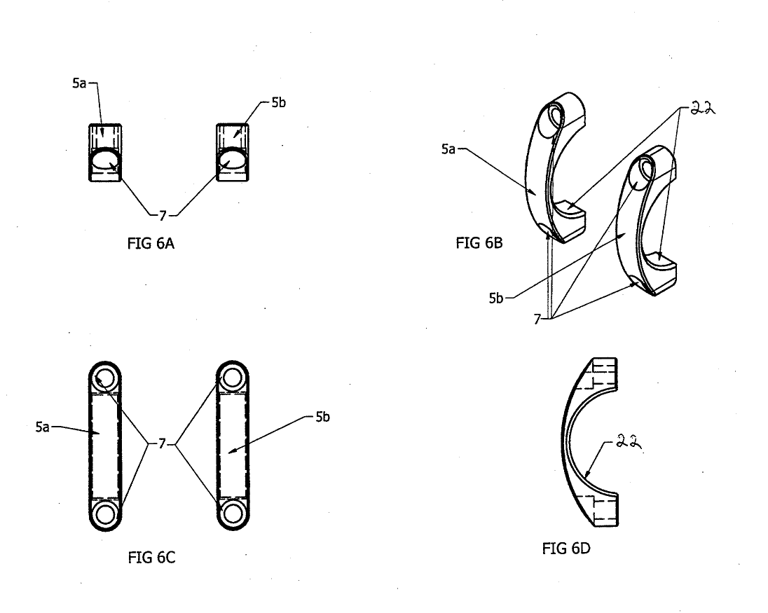

As illustrated in FIG. 6, one embodiment of the clamping mechanism 5 according to the invention described herein, includes two clamping mechanism brackets 5a, and 5b that include a handlebar contact face 22, so as to receive a handlebar tube. The handlebar contact face is defined to accept a tube of a diameter from about 10 mm to about 100 mm, about 20 mm to about 60 mm, about 20 mm to about 50 mm, and about 20 mm to about 40 mm. The clamping mechanism brackets 5a and 5b are then secured to the stem body 13, with the use of threaded fasteners 2 through the threaded fastener holes 7.

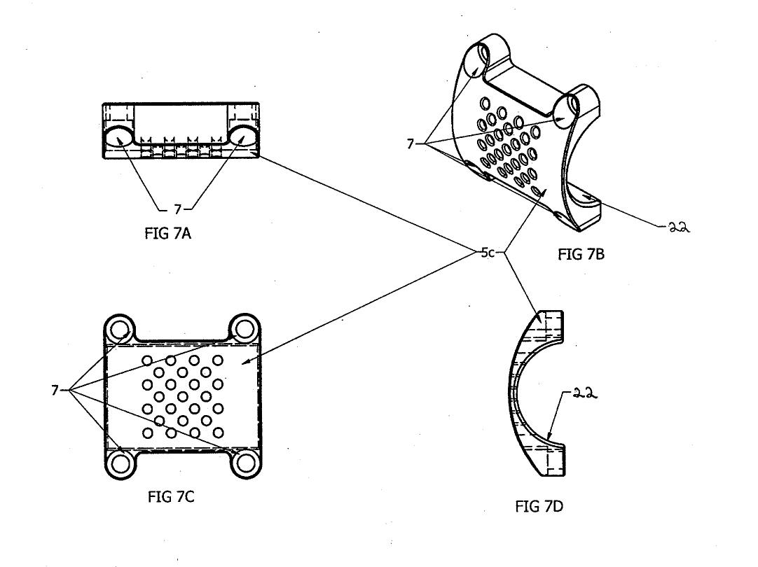

As illustrated in FIG. 7, one embodiment of the clamping mechanism 5 according to the invention includes a single clamping mechanism 5c, that includes a handlebar contact face 22, so as to receive a handlebar tube. The clamping mechanism 5c can then be secured to the stem body 13, with the use of threaded fasteners 2 through the threaded fastener holes, in the clamping mechanism 5c. The clamping mechanism as shown in the embodiment of FIG. 7 may include various designs for both aesthetic purposes and for weight reduction purposes. Similarly, additional designs or weight may be added to the embodiment shown in FIG. 7 without affecting the purpose or function of the clamping mechanism 5c.

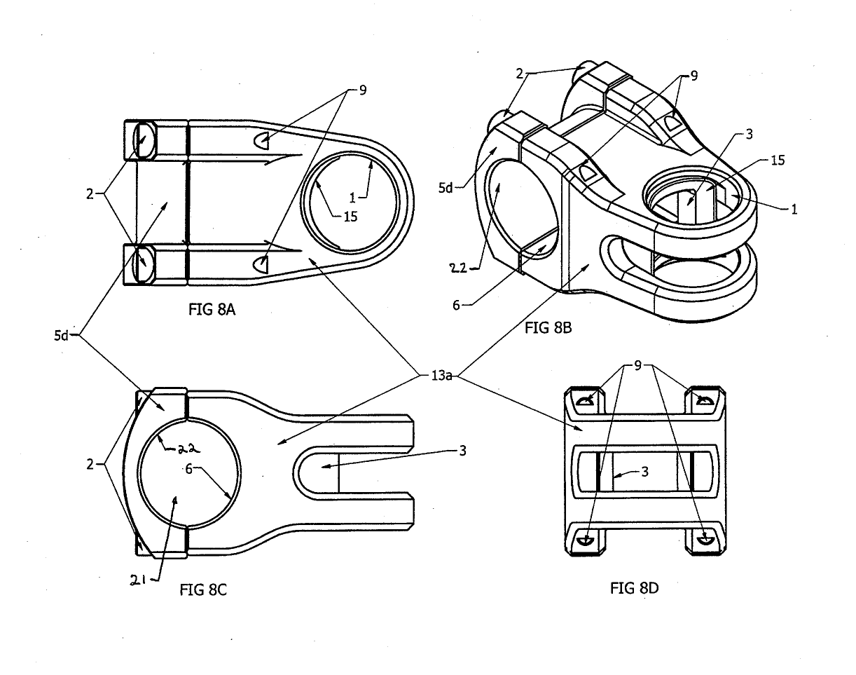

As illustrated in FIG. 8, the stem body 13 according to one embodiment of the invention shows a view of the locking member 3 and how it fits within the cavity 8 and into the steerer tube opening 1. The locking member 3 is of such dimensions that it fits within the cavity 8, but of such length that it extends into both the steerer tube opening 1 and the handlebar opening 21 such that the locking member 3 will be of such locking member length 11 to be in contact with both the steerer tube and the handlebar tube when a steerer tube and a handlebar tube and in the steerer tube opening 1 and the handlebar opening 21. When in contact with both tubes, tightening the clamping member 5 with the threaded fasteners 2 imparts pressure upon the handlebar tube and thereby upon the locking member 3, and thereby translates pressure upon the steerer tube, securing the steerer tube and handlebar by friction from the locking member.

As illustrated in FIGS. 8A, 8B, and 8C, according to one embodiment of the invention described herein, a portion of the locking member 3 protrudes into the steerer tube opening 1. The steerer tube clamping face 15 is shown extending into the steerer tube opening 1.

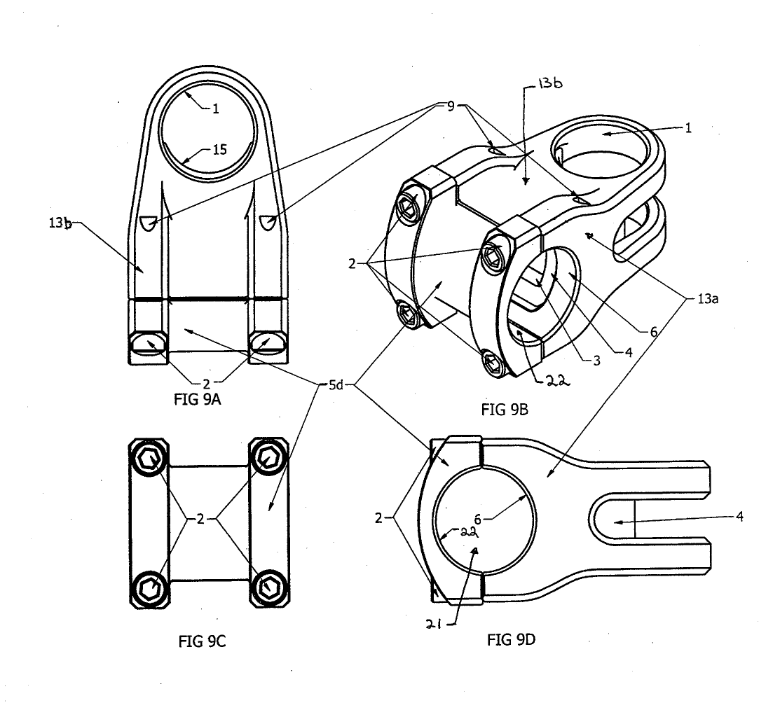

As illustrated in FIG. 9A according to one embodiment of the invention described herein, a portion of the locking member 3, protrudes into the steerer tube opening 1. This figure is shown looking down into the steerer tube 1, through the vertical axis 51 (see FIG. 1A).

As illustrated in FIG. 9B, according to one embodiment of the invention described herein, the bike stem is shown from the handlebar side of the bike stem, and shows the locking member 3, fitting within the stem opening, and also shows the locking member protruding slightly into the steerer tube opening 1. Further, the handlebar clamping face 4 and the handlebar contact face 6 are shown in the figure. As can be seen, the angle and curvature of the handlebar contact face 6 and the handlebar clamping face 4 are the same curvature, and are configured to secure a handlebar tube in the handlebar opening 21.

Alternatively, an embodiment of the invention as illustrated in FIG. 9B allows for the angle and curvature of the handlebar contact face 6 and the handlebar clamping face 4 to be of different curvatures. Similarly, within the steerer tube opening 1, the angle and diameter of the steerer tube opening 1, may be the same angle and diameter as the steerer tube clamping face 15, but, need not be the same angle and diameter. The differences allow the locking member 3, to be interchangeable with other locking members 3, based on the particular fit of a handlebar or steerer tube without the need to replace the entire bike stem.

As illustrated in FIG. 9C, the figure is looking down through the longitudinal axis 50 (see FIG. 1A) and the figure is looking at one embodiment of a clamping member 5d and threated fasteners 2.

As illustrated in FIG. 9D, the bike stem according to one embodiment of the invention described herein, is shown looking down the handlebar opening 21, with the side of the stem body 13a facing up. The handlebar contact face 6 and the clamping member contact face 22 can both be seen, and when configured together creates a handlebar opening 21.

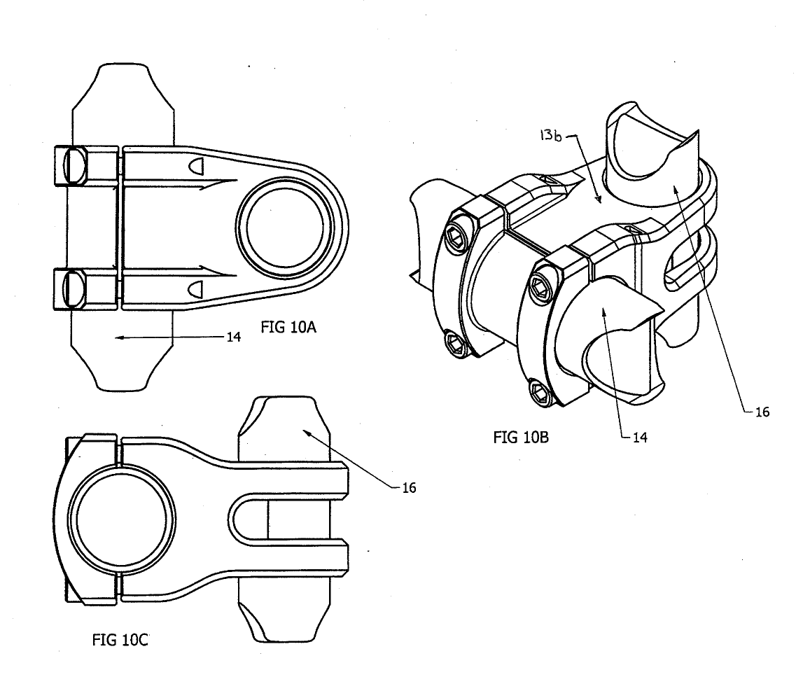

As illustrated in FIG. 10B, according to one embodiment of the invention described herein, the handlebar tube 14 and a steerer tube 16, are shown as they would be attached to the bike stem. The clamping members surround the handlebar 14 and threaded fasteners secure the clamping members around the handlebars 14. As seen in FIG. 10B, the locking member 3 slightly protrudes into the steerer tube opening 1, and is configured to contact a steerer tube 16 within the steerer tube opening 1.

The invention now being fully described, it will be apparent to one of ordinary skill in the art that many changes and modifications can be made thereto without departing from the spirit or scope of the appended claims.

What is claimed is:

1. A bicycle stem comprising:
a. a stem body;
b. said stem body comprising a longitudinal axis, including a first and second longitudinal end regions, said first longitudinal end comprising a continuous surface defining a circular vertically configured opening and a horizontally configured bearing surface at said second end, and a cavity on the longitudinal axis and connecting the vertically configured opening and horizontal bearing surface;
c. a locking member comprising a first end and a second end, configured to a height and width to fit within the cavity, and having the first end comprising a curved bearing face to accept a tube in a substantially vertical manner, and the second end comprising a curved bearing face configured to accept a tube in a substantially horizontal manner, and of such length that the locking member protrudes into the vertically configured opening at the first end and into the horizontally configured opening at the second end; and
d. a clamping mechanism comprising a bearing face in opposed relationship to the bearing face on the second end, said clamping mechanism situated to attach to the second end so as to configure an opening clamping mechanism bearing face and the second end bearing face.

2. The bike stem of claim 1 further comprising threaded fastener holes and where the clamping mechanism comprises openings paired to the threaded fastener holes to secure the clamping mechanism to the stem body with threaded fasteners.

3. A bike stem of claim 1 further comprising threaded fastener holes and where the clamping mechanism comprises two or more clamping mechanisms, each with openings paired to one or more threaded fastener holes to secure the clamping mechanisms to the stem body with threaded fasteners.

4. A locking member of claim 1 further comprising the first end bearing face and the second end bearing face comprising a high friction coefficient surface.

5. A locking member of claim 4 further comprising the first end bearing face and the second end bearing face comprising ridge and groove surfaces.

6. The clamping mechanism of claim 1 further comprising four sides, a front and a back face, where one side is movably attached to the stem body, and where the back face comprises a curved face which comprises an opposing bearing face to the second end of the stem body, and said faces define a tubular opening to accept a portion of a tube, said side opposing the side movably attached to the stem body, comprising openings for threaded fasteners.

7. A clamping mechanism of claim 6 comprising two or more pieces, each comprising four sides a front and a back face, where one face is movably attached to the stem body, and where the back face comprises a curved face which comprises an opposing bearing face to the second end of the stem body, and said faces define a tubular opening to accept a portion of a tube, said side opposing the side movably attached to the stem body, comprising openings for threaded fasteners.

8. The clamping mechanism of claim 6 comprising a latch mechanism to secure said opposing side of the clamping mechanism to the stem body.

9. A bicycle stem, comprising:
a. a stem body having a longitudinal axis and including first and second longitudinal end regions, said first end region of said stem body having a continuous surface defining a tubular opening extending through said stem body for receiving a first member and said second end region of said stem body having a bearing surface, said stem body having a cavity extending longitudinally there through opening at one end onto said continuous surface defining said tubular opening and opening at its other end onto said bearing surface;
b. a locking member movably situated in said body cavity having a longitudinal axis and including first and second longitudinal end regions, said first longitudinal end region of said locking member having a first locking surface and said second longitudinal end region of said locking member having a second locking surface, said locking member having a longitudinal length greater than the distance between the continuous surface defining the tubular opening at said first end region of said stem body and the bearing surface at said second end region of said stem body; and
c. a clamping device situated at said second end region of said stem body, said clamping device having a clamping surface in opposed relationship to said bearing surface at said second end region of said stem body and defining a clamping space between them, said clamping device coupled to said other end region of said stem body and structured and arranged to clamp a second member within said clamping space between said clamping surface and said bearing surface.

10. The bicycle stem of claim 9 wherein said tubular opening at said first end region of said stem body has a first axis extending perpendicular to the longitudinal access of the stem body, and wherein said clamping space defined at said second end region of said stem body has a second axis extending perpendicular to the longitudinal axis of the stem body.

11. The bicycle stem of claim 10 wherein said first axis is substantially perpendicular to said second axis.

12. The bicycle stem of claim 9 wherein said clamping space defined between said clamping surface and said bearing surface comprises a second tubular opening.

13. The bicycle stem of claim 9 wherein said first and second surfaces of said locking member are substantially continuous with said tubular opening-defining surface at said first end region of said stem body and with said bearing surface at said second end region of said stem body, respectively.

14. The bicycle stem of claim 9 wherein said first member comprises a steerer tube and wherein said second member comprises a handlebar.
